(19) United States
(12) Patent Application Publication
(10) Pub. No.: US 2010/0140499 A1
(43) Pub. Date: Jun. 10, 2010

(54) Self-Powered Sanitizing Door Handle

(76) Inventor: Joseph N. Casale, Cary, NC (US)

Correspondence Address: The Law Office of David P. Hendricks, PLLC, P.O. Box 37127, Raleigh, NC, 27627, US

(21) Appl. No.: 12/631,837

(22) Filed: Dec. 6, 2009

Related U.S. Application Data
(60) Provisional application No. 61/120,918, filed on Dec. 9, 2008.

(51) Int. Cl. B01J 19/12; B25G 1/00; E05B 1/00

(52) U.S. Cl. 250/454.11; 16/412

(57) ABSTRACT

The present application is directed to methods and devices for a self-powered sterilizing door handle. The door handle consists of an actuator pivotably attached to a housing. The housing is attached to a door and contains a gear train and a generator. Movement of the actuator rotates the gear train which in turns activates the generator. The generator produces electrical energy that powers a UV light source. The UV light produced by the UV light source is directed to an outer surface of the actuator, thereby deactivating microorganisms on the outer surface.

### CROSS-REFERENCE TO RELATED APPLICATIONS

This application claims priority to Provisional Application Number 61/120,918 filed on Dec. 9, 2008, and is hereby incorporated by reference in its entirety.

### BACKGROUND

The present application is directed generally to door handles, and more specifically to self-powered sanitizing door handles.

Every person is exposed to a multitude of microbes on a daily basis. These microbes may include viral and bacterial diseases and contribute to spreading communicable diseases. Diseases may be transmitted by direct contact when an infected person touches another person, or by indirect contact when there is no direct person-to-person contact. Most often, indirect transfer of disease occurs when an infected person touches a surface and leaves behind microbes on the surface. An uninfected person subsequently touches the same surface and the microbes adhere to the skin. Examples of communicable diseases that may be spread in this way are chicken pox, common cold, conjunctivitis (pinkeye), Hepatitis A and B, herpes simplex (cold sores), influenza, measles, mononucleosis, pertussis, and adeno/rhino viruses.

According to the Center for Disease Control, in the United States alone 200,000 people are hospitalized from influenza complications and 36,000 people die from influenza. The CDC also reports that the influenza virus can survive on inanimate surfaces for 2 to 8 hours. To prevent transfer of influenza from these surfaces, the CDC recommends washing hands often and the use of chemical germicides such as wipes or gels containing alcohol.

However, these preventative measures are impractical to use every time a potentially contaminated surface is touched. For example, most people wash their hands after using bathroom facilities, then touch the doorknob upon leaving the bathroom. The doorknob may contain bacterial diseases left by a prior bathroom user who did not, or inadequately, washed their hands. Generally, a person does not wash their hands again immediately after leaving the bathroom. Similarly, doorknobs in any public space are touched by numerous people infected with contagious diseases. It is not practical for every person using the public space to wash their hands or use a sanitizer after every contact with a doorknob.

### SUMMARY

The present invention is directed to methods and devices for a self-powered sterilizing door handle. The door handle consists of a handle movably attached to a housing. The housing is attached to a door and contains a gear train and a generator. Movement of the door handle rotates the gear train which in turns activates the generator. The generator produces electrical energy that powers a UV light source. The UV light produced by the UV light source is directed to an outer surface of the door handle, thereby deactivating microorganisms on the outer surface.

### BRIEF DESCRIPTION OF THE DRAWINGS

FIG. 1 is a schematic representation of a portion of the electromagnetic spectrum according to one embodiment.

FIG. 2 is a schematic representation of a self-powered sanitizing door handle according to one embodiment.

FIG. 3 is a perspective view of a of a self-powered sanitizing door handle according to one embodiment.

FIG. 4 is a front cut away view of a self-powered sanitizing door handle according to one embodiment.

FIG. 5 is an exploded view of a self-powered sanitizing door handle according to one embodiment.

FIG. 6 is a perspective view of a self-powered sanitizing door handle according to one embodiment.

FIG. 7 is a schematic view of an actuator and a UV light source according to one embodiment.

FIG. 8 is a schematic view of an actuator and multiple UV light sources according to one embodiment.

FIG. 9 is a schematic view of an actuator and multiple UV light sources according to one embodiment.

### DETAILED DESCRIPTION

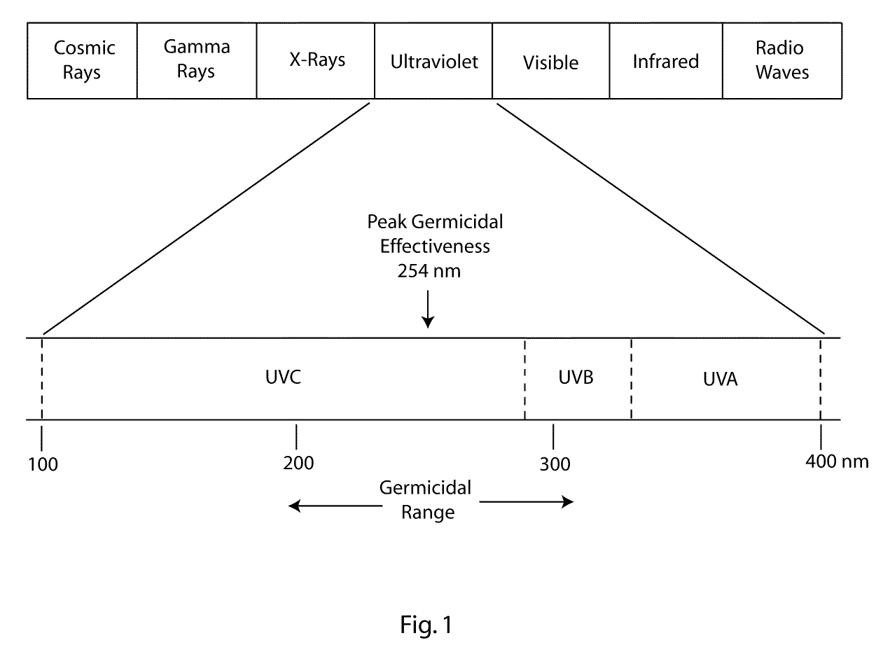

The present application is directed to methods and devices for self-powered sanitizing door handles. An embodiment of the device employs ultraviolet (UV) light to break down or deactivate microorganisms on a surface of the door handle. FIG. 1 illustrates a portion of the spectrum of electromagnetic radiation. UV light occurs in that portion of the spectrum between x-rays and human visible light. The wavelengths of UV light generally fall between about 100 and 400 nm and is characterized into three bands based on interaction with biologic material. The first band is UVC in the 100 to 280 nm range, followed by UVB in the 280 to 315 nm range. Finally, UVA is in the 315 to 400 nm range.

UVC, because of its shorter wavelength, has a higher energy level than UVA or UVB. At these higher energy levels, UVC is considered to be mutagenic to microorganisms such as bacteria, viruses, mold spores, and other microorganisms. While all UVC has some germicidal effect, UVC at a wavelength of about 254 nm has been found to be the most effective. UVC at this wavelength breaks the molecular bonds within the DNA of microorganisms, forming pyrimidine dimers from thymine and cytosine in the DNA. Covalent bonds are formed between certain adjacent bases in the DNA which prevent the DNA from being unzipped for replication. In spores, it is believed that lethal photoproducts are formed within the spores as a result of the UVC exposure. The microorganism is unable to reproduce, and when it does try to replicate, it dies. Thus, exposure to UVC renders the microorganism ineffective, and disease transmission is stopped.

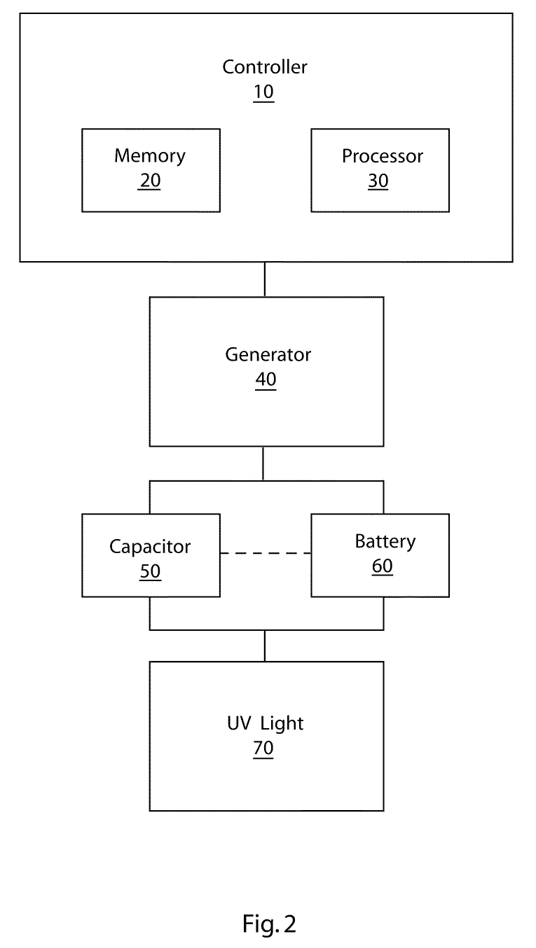

FIG. 2 illustrates a schematic representation of an embodiment of the device. A controller 10 may include a microprocessor 30 and associated memory 20. The memory 20 may store operational parameters of the device, as well as software to control operation of the device. The microprocessor 30 may perform operations according to the software using the operational parameters as well as other parameters or information obtained by the controller 10. A generator 40 produces electrical energy which may be stored by a capacitor 50 and/or a battery 60. The electrical energy is fed either directly from the generator or from the capacitor 50 or battery 60, or both, to a UV light source 70.

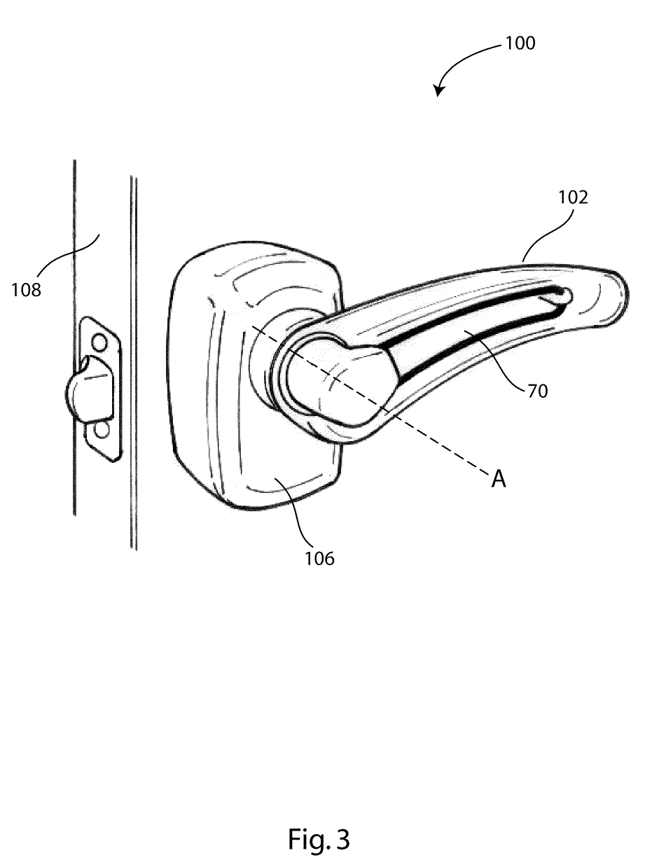

An embodiment of the device is illustrated in FIG. 3 as a lever door handle 100 installed on a door 108. Lever-type door handles 100 are characterized by an actuator 102 that rotates about an axis A generally perpendicular to the plane of the door 108. The lever door handle 100 comprises a housing 106, the actuator 102 pivotably secured within the housing 106, and a UV light source 104. The housing may contain the controller 10 and other components as discussed below to power the UV light source 70. The UV light source 70 may be positioned within the actuator 102. In one embodiment, the actuator 102 is constructed of a material translucent to UV light.

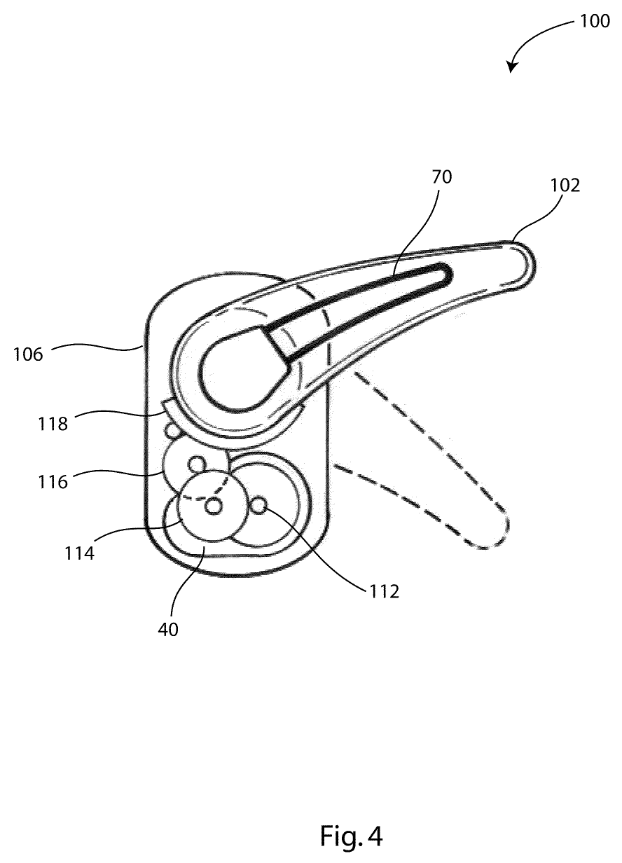

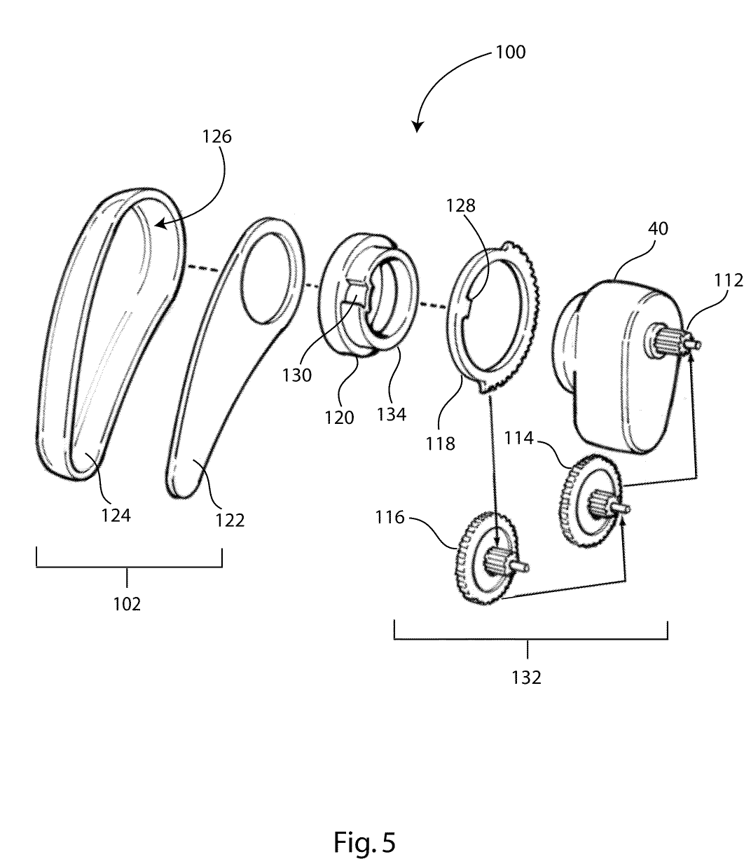

FIG. 4 illustrates a front cutaway view and FIG. 5 illustrates an exploded view of an embodiment of the lever door handle 100. The actuator 102 is comprised of an actuator cover 124 and actuator back 122. The actuator cover 124 and actuator back 122 define a hollow space 126 in which the UV light source 70 may be positioned. A collar 120 attached to the actuator 102 translates movement of the actuator 102 to a gear train 132. Movement of the actuator 102 from an upper position to a lower position (the lower position indicated by the dashed lines in FIG. 4) causes the collar 120 to rotate. A flange 134 on the collar 120 fits within an opening in segment gear 118. A key 128 on the segment gear 118 fits within a slot 130 in the flange 134, thus the segment gear rotates along with the collar 120.

As the actuator 102 is moved from the upper position to the lower position, the segment gear 118 rotates first pinion gear 116 which in turn rotates second pinion gear 114. The second pinion gear 114 engages the generator drive gear 112 and operates the generator 40. Operation of the generator 40 produces electrical energy to power the UV light source 70. The exact configuration of the gear train 132 (diameter of individual gears, number of teeth per gear, etc.) may be selected such that movement of the actuator 102 from the upper position to the lower position produces adequate rotation of the generator drive gear 112 to produce enough electrical energy to power the UV light source 70. A variety of gear train configurations other than that illustrated in FIGS. 4 and 5 may be selected as known to one skilled in the art. The precise configuration selected does not deviate from the scope of the present invention.

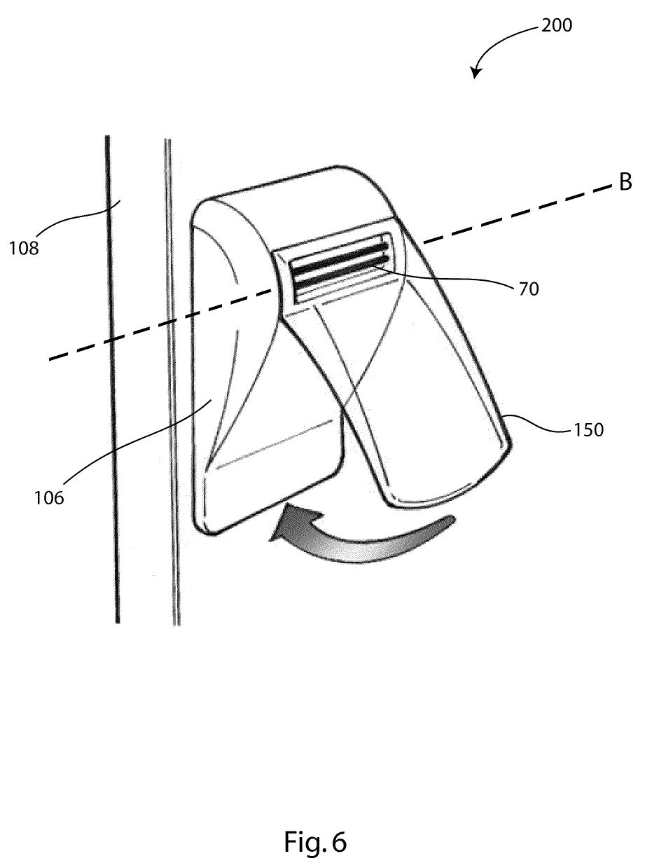

FIG. 6 illustrates an embodiment of a paddle door handle 200 mounted on the door 108. Paddle handles 200 are characterized by a paddle actuator 150 that rotates about an axis B generally parallel to the plane of the door 108. The paddle handle 200 is comprised of the paddle actuator 150 pivotably secured within a housing 106. The housing 106 is attached to the door 108. As described previously for the lever handle 100, pressing on the paddle actuator 150 causes rotation of a gear train 132 (not shown in FIG. 6). Rotation of the gear train 132 in turn actuates a generator 40 (not shown in FIG. 6) which generates electrical energy to power the UV light source 70.

FIGS. 4-6 illustrate two embodiments of door handles adapted for use with the present invention. These embodiments are for illustrative purposes only and are not limiting. Embodiments of the present device may be adapted for essentially any style door handle or door knob.

The actuator 102, 150 in an embodiment of the present device is constructed at least partially of a material that is translucent to UV light. The UV light source 70 may be positioned within the actuator 102, 150. The UV light passes through the translucent actuator 102, 150 and illuminates microorganisms on an outer surface of the actuator 102, 150. Example materials suitable for the translucent actuator 102, 150 include glass, polyethylene, and acrylics.

The electrical energy produced by the generator 40 should be sufficient to power the UV light source 70 for a period of time sufficient to adequately sanitize the outer surface of the actuator 102, 150. The precise period of time will depend on the UVC translucency of the actuator 102, 150 material, the intensity of light output by the UV light source 70, and the microorganisms to be killed. Assuming a UVC light intensity of 1,000 μW/cm², the period of time may range from about 1 to about 10 seconds.

Depending on the gear train 132 and generator 40 selected for a particular embodiment, one cycle of the actuator 102, 150 may not produce sufficient electrical energy to power the UV light source 70 for the selected period of time. Embodiments of the device may include the capacitor 50 and/or battery 60 to store the generated electrical energy. The controller 10 may then monitor the capacitor 50 and/or battery 60 and turn on the UV light source 70 once sufficient charge has been stored to operate the UV light source 70 for the selected period of time.

The UV light source 70 in an embodiment of the device is a low pressure mercury vapor tube lamp that preferentially produces UVC light at a wavelength of 254 nm. In one embodiment, the UVC light intensity is about 1,000 μW/cm², and in another embodiment the UVC light intensity is about 1,500 μW/cm². Other UV light sources may be used in the present device without deviating from the scope of the present application.

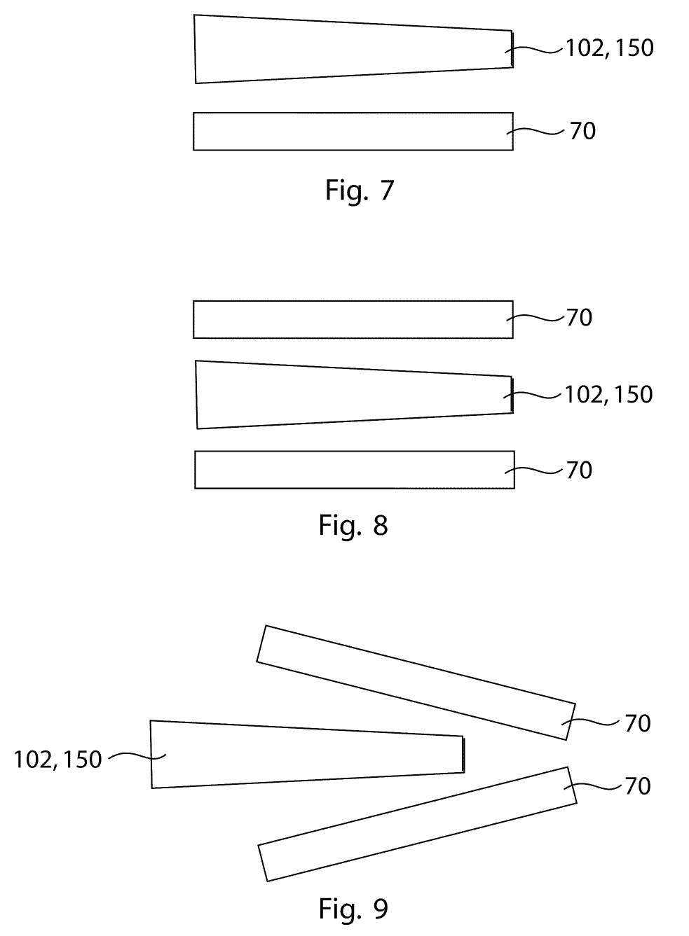

As illustrated in FIGS. 3-6, the UV light source 70 may be positioned within the actuator 102, 150. In other embodiments, the UV light source 70 may be positioned outside of the actuator 102, 150, oriented to illuminate an outer surface of the actuator 102, 150. FIG. 7 schematically illustrates a single UV light source 70 illuminating the actuator 102, 150. FIG. 8 schematically illustrates two UV light sources 70 in a first orientation illuminating the actuator 102, 150, and FIG. 9 illustrates two UV light sources 70 in a second orientation illuminating the actuator 102, 150. As is apparent to one skilled in the art, any number and orientation of UV light sources 70 may be used in the present device.

In an embodiment of the device, movement of the door 108, rather than movement of the actuator 102, 150, provides the mechanical energy that powers the generator 40. In this embodiment, a hinge-like mechanism extends from an edge of the door 108 in proximity to where the door 108 is mounted to a door frame. As the door 108 opens and closes (similar to the movement of the actuator 102, 150 described above), the hinge-like mechanism turns the gear train 132 attached to the generator 40. The generator 40 produces electrical energy as described above to power the UV light source 70.

Another aspect of the present invention relates to methods to sanitize a door handle. The method includes providing an actuator 102, 150 operatively connected to an electrical generator 40. The actuator 102, 150 is moved from a first position to a second position. The movement of the actuator 102, 150 activates the generator 40 which produces electrical energy. The electrical energy activates a UV light source 70 that produces UVC light. The UVC light is directed to an outer surface of the actuator 102, 150 and illuminates microorganisms thereon. The UV light source 70 is illuminated for a period of time sufficient to kill or render harmless most if not all of the microorganisms.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising”, and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A self-powered sanitizing door handle, comprising:
a housing;
an actuator pivotably connected to the housing, the actuator adapted to be contacted by a user when the user operates the door handle;
a generator for generating electrical energy; and
a UV light source;
wherein the generator is operatively connected to the actuator such that movement of the actuator causes the generator to generate electrical energy, the electrical energy subsequently used to power the UV light source.

2. The door handle of claim 1, wherein the generator is positioned within the housing and operatively connected to the actuator by a gear train.

3. The door handle of claim 1, wherein the UV light source is positioned within the actuator.

4. The door handle of claim 1, wherein the UV light source is powered for a predetermined period of time each time the user operates the door handle.

5. The door handle of claim 4, wherein the predetermined period of time is about 1 second to about 10 seconds.

6. The door handle of claim 1, wherein the UV light source has a power output of about 1,000 microwatts per square centimeter.

7. The door handle of claim 1, wherein the UV light source is capable of producing UVC light.

8. The door handle of claim 1, wherein the UV light source is capable of producing UVC light primarily with a wavelength of about 254 nanometers.

9. The door handle of claim 1, further comprising a capacitor for storing electrical energy, wherein at least a portion of the electrical energy generated by the generator is stored by the capacitor prior to discharge by the capacitor, and at least a portion of the electrical energy discharged by the capacitor is used to power the UV light source.

10. A self-powered sanitizing door handle, comprising:
a housing for attaching the door handle to a door;
an actuator pivotably connected to the housing, the actuator contacted by a user when the user operates the door handle;
a generator for generating electrical energy spaced apart from the housing; and
a UV light source;
wherein the generator is operatively connected to the door such that moving the door by the user causes the generator to generate electrical energy, the electrical energy subsequently used to power the UV light source.

11. The door handle of claim 10, further comprising a gear train connected to the door such that movement of the door is translated into movement of the gear train, the gear train movement causing operation of the generator to generate electrical energy.

12. The door handle of claim 10, wherein the UV light source is positioned within the actuator.

13. The door handle of claim 10, wherein the UV light source is powered for a predetermined period of time each time the user operates the door handle.

14. The door handle of claim 13, wherein the predetermined period of time is about 1 second to about 10 seconds.

15. The door handle of claim 10, wherein the UV light source has a power output of about 1,000 microwatts per square centimeter.

16. The door handle of claim 10, wherein the UV light source is capable of producing UVC light.

17. The door handle of claim 10, wherein the UV light source is capable of producing UVC light primarily with a wavelength of about 254 nanometers.

18. A self-powered sanitizing door handle, comprising:
a housing;
an actuator pivotably connected to the housing, the actuator adapted to be contacted by a user when the user operates the door handle;
a generator for generating electrical energy; and
a UV light source spaced apart from the actuator;
wherein the generator is operatively connected to the actuator such that movement of the actuator causes the generator to generate electrical energy, the electrical energy subsequently used to power the UV light source.

19. The door handle of claim 18, wherein the UV light source has a power output of about 1,000 microwatts per square centimeter.

20. The door handle of claim 18, wherein the UV light source is capable of producing UVC light primarily with a wavelength of about 254 nanometers.
